(19) United States
(12) Patent Application Publication
(10) Pub. No.: US 2025/0054113 A1
(43) Pub. Date: Feb. 13, 2025

(54) METHOD AND APPARATUS FOR CORRECTING A VALUE OF A CORRECTION TARGET PIXEL OF AN IMAGE OF AN ELECTRONIC CAMERA

(71) Applicant: Basler AG, Ahrensburg (DE)

(72) Inventors: Jonas Karp, Prisdorf (DE); Iris Ellerkamp, Lübeck (DE); Jörg Kunze, Ahrensburg (DE)

(21) Appl. No.: 18/797,832

(22) Filed: Aug. 8, 2024

(30) Foreign Application Priority Data
Aug. 9, 2023 (DE) 10 2023 121 216.8

(51) Int. Cl. G06T 5/70; G06T 5/20

(52) U.S. Cl. CPC G06T 5/70; G06T 5/20

(57) ABSTRACT

A correction method for correcting a value of a correction target pixel of an image of an electronic camera comprises determining a corrected value of the correction target pixel by way of filtering, which is based on a weighted averaging of the value of the correction target pixel and an estimation value, wherein the weighted averaging is based on weight values for the correction target pixel and for the estimation value. The weight values are based on an inhomogeneity value, which is determined based on a deviation of the value of the correction target pixel from at least one neighborhood value, which is based on values of a plurality of pixels of a neighborhood of the correction target pixel.

### BACKGROUND

### Technical Field

The present disclosure relates to a correction method for correcting a value of a correction target pixel of an image of an electronic camera. The disclosure further relates to a corresponding correction apparatus and an electronic camera comprising an image sensor and the correction apparatus. The disclosure further relates to a computer apparatus and a computer program product.

### Description of the Related Art

Disturbing image artifacts occur in image sensors when pixels show an electrical behavior that deviates in an inhomogeneous way from the electrical behavior of the neighborhood pixels. In particular, occasional strong deviations are perceived by the viewer as disturbing image errors.

The present disclosure provides a method and an apparatus for correcting images which are affected by inhomogeneity-based image errors, wherein the method or the apparatus are preferably configured to dynamically recognize in particular strong deviations of individual pixels and to correct them in such a way that the image is judged by the viewer to be largely error-free (or at least improved) with respect to the said error sources.

Furthermore, it is a desirable auxiliary constraint that the interference with the image data is minimal, so that the image data is distorted as little as possible.

### BRIEF SUMMARY

The present disclosure provides a correction method for correcting a value of a correction target pixel of an image of an electronic camera, which is suitable for fulfilling one or more, preferably as many as possible, of the above-mentioned requirements. Furthermore, the disclosure provides a corresponding correction apparatus as well as a computer apparatus and a computer program product. Finally, the disclosure provides an electronic camera comprising the correction apparatus according to the disclosure.

According to a first aspect, the present disclosure provides a correction method for correcting a value of a correction target pixel of an image of an electronic camera, wherein the correction method comprises:
determining a corrected value of the correction target pixel by means of a filtering, which is based on a weighted averaging of the value of the correction target pixel and an estimation value, wherein the weighted averaging is based on weight values for the correction target pixel and for the estimation value,
wherein the weight values are based on an inhomogeneity value, which is determined based on a deviation of the value of the correction target pixel from at least one neighborhood value, which is based on values of a plurality of pixels of a neighborhood of the correction target pixel.

The present disclosure is based on the inventors' idea of using a filter to correct pixel values that deviate due to inhomogeneity. The correction of the value of a correction target pixel comprises determining a corrected value of the correction target pixel by means of a filtering. The filtering is based on a weighted averaging of the value of the correction target pixel and an estimation value, wherein the weighted averaging is based on weight values for the correction target pixel and for the estimation value. The weight values are based on an inhomogeneity value, which is determined based on a deviation of the value of the correction target pixel from at least one neighborhood value, which is based on values of a plurality of pixels of a neighborhood of the correction target pixel. Because the weight values are based on the inhomogeneity value, they can be determined dynamically in such a way that the filtering is adapted as good as possible to the actual inhomogencity present.

According to an advantageous further development of the disclosure, if the inhomogeneity value indicates a smaller inhomogeneity, the weight values are selected such that the value of the correction target pixel is weighted more heavily than if the inhomogeneity value indicates a greater inhomogeneity, and the estimation value is weighted less heavily than if the inhomogeneity value indicates a greater inhomogeneity. In this way, a high-quality correction can be achieved, since if the existing inhomogeneity is smaller, the value of the correction target pixel is included more strongly in the corrected value (and the estimation value more weakly), and if the existing inhomogeneity is greater, the value of the correction target pixel is included less strongly in the corrected value (and the estimation value more strongly). The value of the correction target pixel is therefore only corrected with the estimation value as much as necessary, depending on the existing inhomogencity.

According to an advantageous further development of the disclosure, the weighted averaging is performed continuously in dependence of the inhomogeneity value. This has the advantage compared to a discontinuously operating correction, which operates, for example, with a case distinction, that small deviations of the value of the correction target pixel from the at least one neighborhood value do not lead to strong jumps in the corrected value of the filtering target pixel. Such jumps in the corrected values are often perceived by the viewer as extremely disturbing, especially in image sequences, and are referred to as blink artifacts.

It is preferred that the inhomogeneity value has a value range from a minimum value, which indicates a minimum inhomogeneity, to a maximum value, which indicates a maximum inhomogeneity, wherein, if the inhomogeneity value is equal to the minimum value, the value of the correction target pixel is weighted maximally, preferably with a weight value equal to 1, and the value of the estimation value is weighted minimally, preferably with a weight value equal to 0, and, if the inhomogeneity value is equal to the maximum value, the value of the correction target pixel is weighted minimally, preferably with a weight value equal to 0, and the value of the estimation value is weighted maximally, preferably with a weight value equal to 1. This ensures that the weighted averaging cannot leave the range of the continuous transition between the value of the correction target pixel and the estimation value.

It is also preferred that the minimum value is 0 and the maximum value is 1, wherein the weight value for the correction target pixel is equal to 1 minus the inhomogeneity value and the weight value for the estimation value is equal to the inhomogeneity value. In this case, the weight values can thus be determined particularly easily from the inhomogencity value.

The terms “maximum value” and “minimum value” here refer to the specification of a minimum and maximum inhomogeneity. The values can be defined arbitrarily and it is not necessary, for example, for the maximum value to correspond to a larger number than the minimum value. In an exemplary definition, for example, the value 1 could indicate a minimum inhomogeneity (minimum value) and the value 0 could indicate a maximum inhomogeneity (maximum value).

It is preferred that the neighborhood of the correction target pixel is a 5×5 neighborhood. It is a realization of the inventors that a 5×5 neighborhood enables a good compromise between efficient processing, in particular with regard to the determination of the inhomogeneity value and the estimation value, and a high-quality correction. For example, if the correction target pixel is labeled P22, the 5×5 neighborhood of the correction target pixel consists of the 24 pixels P00, P01, P02, P03, P04, P10, P11, P12, P13, P14, P20, P21, P23, P24, P30, P31, P32, P33, P34, P40, P41, P42, P43 and P44. The correction target pixel is therefore surrounded by two pixels of the 5×5 neighborhood in each direction.

According to an advantageous further development of the disclosure, the at least one neighborhood value comprises a first value and/or a second value, wherein the inhomogeneity value is determined based on a comparison of the value of the correction target pixel with the first value and/or a comparison of the value of the correction target pixel with the second value. The values of pixels with highly inhomogeneous properties often deviate solitarily from the values of the neighborhood pixels. Therefore, the inhomogeneity value can be determined in a simple manner by comparing the value of the correction target pixel with the first and/or second value, which are based on the values of the plurality of pixels of the neighborhood of the correction target pixel.

According to an advantageous further embodiment of the disclosure, if the value of the correction target pixel is less than or equal to the first value, and/or if the value of the correction target pixel is greater than or equal to the second value, the inhomogeneity value indicates that the correction target pixel has no inhomogeneity. This reflects the heuristic that the value of a pixel that has no inhomogeneity is usually less than or equal to a large value and/or greater than or equal to a small value, wherein the values are based on the values of the plurality of pixels of the neighborhood of the correction target pixel. An inhomogeneity is only present if the value of the correction target pixel is greater than or equal to the first value and/or if the value of the correction target pixel is less than or equal to the second value. It is preferred that the inhomogeneity value is determined in such a way that it increases continuously with increasing difference from the first value and/or with increasing difference from the second value. This ensures a continuous relationship between the strength of the inhomogeneity and the inhomogeneity value.

According to an advantageous further development of the disclosure, the first value is determined based on the m1-t largest value of the pixels of the plurality of pixels of the neighborhood of the correction target pixel and/or the second value is determined based on the m2-t smallest value of the pixels of the plurality of pixels of the neighborhood of the correction target pixel, wherein m1 and m2 are natural numbers and are preferably equal to 1 or 2. As described, the values of pixels with highly inhomogeneous properties often deviate solitarily from the values of the neighborhood pixels. Thus, if the correction target pixel exhibits inhomogeneity, the value of the correction target pixel should typically be greater than or equal to the largest value (m1 equal to 1) and/or less than or equal to the smallest value (m2 equal to 1) of the pixels of the plurality of pixels of the neighborhood of the correction target pixel.

Of course, in practice it can also happen that more than one pixel within a neighborhood has a high degree of inhomogeneity. For example, two or three pixels may be affected by greater inhomogeneity. However, since highly inhomogeneous pixels by definition only occur rarely, the probability of such an occurrence decreases sharply as the number of pixels affected by a high inhomogeneity within a neighborhood increases. In this respect, the cases in which two pixels within a neighborhood are affected by inhomogeneity are of particular importance. This situation can be taken into account by subjecting the values of the pixels of the plurality of pixels in the neighborhood of the correction target pixel to rank filtering (RF). If, for example, m1 and/or m2 are set to 2, the comparison of the value of the correction target pixel with the first value and/or the second value is not carried out with the largest value and/or the smallest value, but with the second largest value and/or the second smallest value. This makes it possible to reduce the influence of any second pixel affected by inhomogeneity in the neighborhood of the correction target pixel. It is possible to set m1 and m2 to the same value or to set them so that they differ from each other.

According to an advantageous further development of the disclosure, the first value is determined based on the n1-t largest extrapolation value of at least two extrapolation values, which are determined based on the plurality of pixels of the neighborhood of the correction target pixel, and/or the second value is determined based on the n2-t smallest extrapolation value of the at least two extrapolation values, wherein n1 and n2 are natural numbers and are preferably equal to 1 or 2. The use of extrapolation values, which are determined based on the plurality of pixels of the neighborhood of the correction target pixel, in addition or alternatively to the (direct) use of the values of the pixels of the plurality of pixels of the neighborhood of the correction target pixel, is advantageous in situations where an ascending or descending image structure ends in the correction target pixel. In such a case, the value of the correction target pixel can be greater than or equal to the largest value (n1 equal to 1) and/or less than or equal to the smallest value (n2 equal to 1) of the pixels of the plurality of pixels of the neighborhood of the correction target pixel without the correction target pixel being affected by inhomogeneity. The use of extrapolation values allows this case to be taken into account when determining the inhomogeneity value.

As described above, it can also occur in practice that more than one pixel within a neighborhood has a high degree of inhomogeneity. This situation can also be taken into account here by subjecting the extrapolation values to rank filtering (RF). For example, if n1 and/or n2 is set to 2, the comparison of the value of the correction target pixel with the first value and/or the second value is not carried out with the largest extrapolation value and/or the smallest extrapolation value, but with the second largest extrapolation value and/or the second smallest extrapolation value. This allows the influence of any second pixel affected by inhomogeneity in the neighborhood of the correction target pixel to be reduced. It is possible to set n1 and n2 to the same value or to set them so that they differ from each other.

According to an advantageous further development of the disclosure, the at least two extrapolation values are each determined based on values of pixels of the plurality of pixels of the neighborhood of the correction target pixel, which run directly towards the correction target pixel (P22) in different directions. In this way, ascending and/or descending image structures which end in the correction target pixel can be taken into account when determining the inhomogeneity value, irrespective of their direction.

It is preferred that the different directions comprise the directions horizontally from the left and/or horizontally from the right and/or vertically from above and/or vertically from below and/or diagonally from above left and/or diagonally from below right and/or diagonally from above right and/or diagonally from below left. For example, in a linear extrapolation in the direction horizontally from the left, a first extrapolation value can be determined as E_1=2·P21−P20 and in the direction horizontally from the right, a second interpolation value can be determined as E_2=2·P23−P24.

It is further preferred that the at least two extrapolation values are determined based on an extrapolation selected from the group consisting of a linear extrapolation, a quadratic extrapolation, a cubic extrapolation, a higher degree polynomial extrapolation, a trigonometric extrapolation and a logarithmic extrapolation. By selecting a suitable extrapolation, this can be adapted in the best possible way to the increasing and/or decreasing image structures to be expected in the image.

According to an advantageous further development of the disclosure, the first value is determined based on the m1-t largest value of the pixels of the plurality of pixels of the neighborhood of the correction target pixel and the n1-t largest extrapolation value of the at least two extrapolation values and/or the second value is determined based on the m2-t smallest value of the pixels of the plurality of pixels of the neighborhood of the correction target pixel and the n2-t smallest extrapolation value of the at least two extrapolation values. In this way, the comparison of the value of the correction target pixel with the m1-t largest and/or m2-smallest value of the pixels of the plurality of pixels of the neighborhood of the correction target pixel and the comparison of the value of the correction target pixel with the n1-t largest and/or n2-t smallest extrapolation value are suitably combined. It is possible to set m1, m2, n1 and n2 all to the same value or to set them so that they are at least partially different from each other. For example, m1 and n1 could be set to the value 2 and m2 and n2 could be set to the value 1 (or vice versa), or, for example, only one value, such as n2, could be set to the value 2 and the other values could be set to the value 1.

Even if a pixel has no inhomogeneity, temporal or spatial noise, for example, can cause the value of the pixel to fulfil the aforementioned criteria and thus incorrectly assign it an inhomogeneity value that indicates a relevant inhomogeneity.

According to an advantageous further development of the disclosure, the m1-t largest value of the pixels of the plurality of pixels of the neighborhood of the correction target pixel and/or the n1-t largest extrapolation value of the at least two extrapolation values is additionally increased by a first offset value and/or the m2-t smallest value of the pixels of the plurality of pixels of the neighborhood of the correction target pixel and/or the n2-t smallest extrapolation value of the at least two extrapolation values is additionally reduced by a second offset value, wherein the first offset value is equal to or different from the second offset value. As a result, values that occur within the natural noise are not or are only slightly changed by the filter.

According to an advantageous further development of the disclosure, the inhomogeneity value that is based on the deviation of the value of the correction target pixel from the at least one neighborhood value is additionally scaled by a scaling factor, for example, by multiplying its value by a factor or dividing it by a reciprocal factor during the determination. The scaling allows the behavior of the filter to be adapted in such a way that, on the one hand, the pixels that stand out as inhomogeneous are sufficiently corrected and, on the other hand, the pixels that do not stand out as inhomogeneous experience no or only a slight change due to the filter.

According to an advantageous further development of the disclosure, the estimation value is determined based on an interpolation, a median formation or an averaging of the values of pixels in the neighborhood of the correction target pixel. In particular, known interpolation methods can be used. In particular, it is preferred that the interpolation is selected from the group consisting of a linear interpolation, a quadratic interpolation, a cubic interpolation, a higher degree polynomial interpolation, a piecewise interpolation, a spline interpolation, a trigonometric interpolation and a logarithmic interpolation.

According to an advantageous further development of the disclosure, the interpolation is based on a one-dimensional interpolation or a two-dimensional interpolation.

According to an advantageous further development of the disclosure, a direction estimation value, which indicates an estimation value of the direction of an image structure within the neighborhood of the correction target pixel, is determined, and the interpolation is based on a one-dimensional interpolation in the direction of the image structure indicated by the direction estimation value. It is a realization of the inventors that in images a one-dimensional interpolation often provides better results than a two-dimensional interpolation, provided that the one-dimensional interpolation is performed in the direction of an image structure present in the image. Such image structures can, for example, consist of the edges of objects, such as those found in the outer contour of letters, or in lines that make up a barcode, for example. In such a case, the interpolation result is better if the interpolation is carried out parallel to the edge or to the lines of the barcode, for example, than in a different direction, in particular orthogonal to it. The estimated direction value serves as an indicator of whether, for example, there is a predominantly horizontal, vertical or ascending or descending diagonal image structure in the neighborhood of the correction target pixel.

According to an advantageous further embodiment of the disclosure, the direction estimation value is determined based on a comparison of a weighted sum of the magnitudes of pairwise differences of the values of pixels of the neighborhood of the correction target pixel arranged in a first direction with respect to each other with a weighted sum of the magnitudes of pairwise differences of the values of pixels of the neighborhood of the correction target pixel arranged in a second direction with respect to each other.

According to an advantageous further embodiment of the disclosure, the direction estimation value is determined based on a comparison of weighted sums of the magnitudes of pairwise differences of the values of pixels of the neighborhood of the correction target pixel, which are arranged in a plurality of directions with respect to each other, wherein a plurality of estimation values are determined based on one-dimensional interpolations in the plurality of directions, wherein the estimation value is based on a weighted averaging of the plurality of estimation values, wherein the weighted averaging is based on weight values for the plurality of estimation values, wherein the weight values are based on the direction estimation value. This type of processing has the advantage of avoiding the occurrence of blink artifacts in image sequences.

According to a further aspect, the present disclosure provides a correction apparatus for correcting a value of a correction target pixel of an image of an electronic camera, wherein the correction apparatus is configured to:
determine a corrected value of the correction target pixel by means of a filtering, which is based on a weighted averaging of the value of the correction target pixel and an estimation value, wherein the weighted averaging is based on weight values for the correction target pixel and for the estimation value,
wherein the weight values are based on an inhomogeneity value, which is determined based on a deviation of the value of the correction target pixel from at least one neighborhood value, which is based on values of a plurality of pixels of a neighborhood of the correction target pixel.

According to a further aspect, the present disclosure provides an electronic camera, wherein the electronic camera comprises:
an image sensor having pixels for generating an image; and
the correction apparatus according to claim 17 for correcting a value of a correction target pixel of the image.

According to a further aspect, the present disclosure provides a computer apparatus, wherein the computer apparatus comprises a computing unit, which is configured to perform any of the correction methods described herein.

According to a further aspect, the present disclosure provides a computer program product, wherein the computer program product comprises a non-transitory computer-readable medium containing executable code for causing a computer apparatus to execute any of the correction methods described herein when the code is executed on the computer apparatus.

It will be understood that the various embodiments of the correction method, the correction apparatus, the electronic camera, the computer apparatus, and the computer program product described herein have similar and/or identical preferred embodiments, in particular as defined by additional dependent features.

It is to be understood that a preferred embodiment of the disclosure may also be any combination of the dependent claims with the corresponding independent claim.

### BRIEF DESCRIPTION OF THE SEVERAL VIEWS OF THE DRAWINGS

Preferred embodiments of the present disclosure are described in more detail below with reference to the accompanying figures, wherein:

FIG. 1 schematically and exemplarily shows the structure and function of an electronic camera,

FIG. 2 schematically and exemplarily shows a pixel and a 5×5 neighborhood of a pixel,

FIG. 3 schematically and exemplarily shows a correction method for correcting a value of a correction target pixel of an image of an electronic camera according to an embodiment of the disclosure,

FIG. 4 schematically and exemplarily shows values for an otherwise homogeneous image area in which a pixel assumes an increased value due to an inhomogeneity,

FIG. 5 schematically and exemplarily shows values for an image area that depicts a point-shaped bright spot, a so-called highlight, without inhomogeneity,

FIG. 6 schematically and exemplarily shows the determination of extrapolation values based on a plurality of pixels of the neighborhood of the correction target pixel,

FIG. 7 schematically and exemplarily shows pixels of the plurality of pixels of the neighborhood of the correction target pixel, which run directly towards the correction target pixel in different directions,

FIG. 8 schematically and exemplarily shows the increase of the first value by the first offset value or the decrease of the second value by the second offset value,

FIG. 9 schematically and exemplarily shows details of the determination of the inhomogeneity value according to an embodiment of the disclosure,

FIG. 10 schematically and exemplarily shows the determination of the weighted sum of the magnitudes of pairwise differences of the values of pixels arranged horizontally with respect to each other, and

FIG. 11 schematically and exemplarily shows details of the determination of the estimation value according to an embodiment of the disclosure.

### DETAILED DESCRIPTION

In the figures, identical or corresponding elements or units are each provided with identical or corresponding reference signs. If an element or unit has already been described in connection with a figure, it may not be described in detail in connection with another figure. The terms “left”, “right”, “top”, “bottom”, etc., used in the description of the figures refer to the corresponding figure in an orientation with a normally legible figure designation and reference signs.

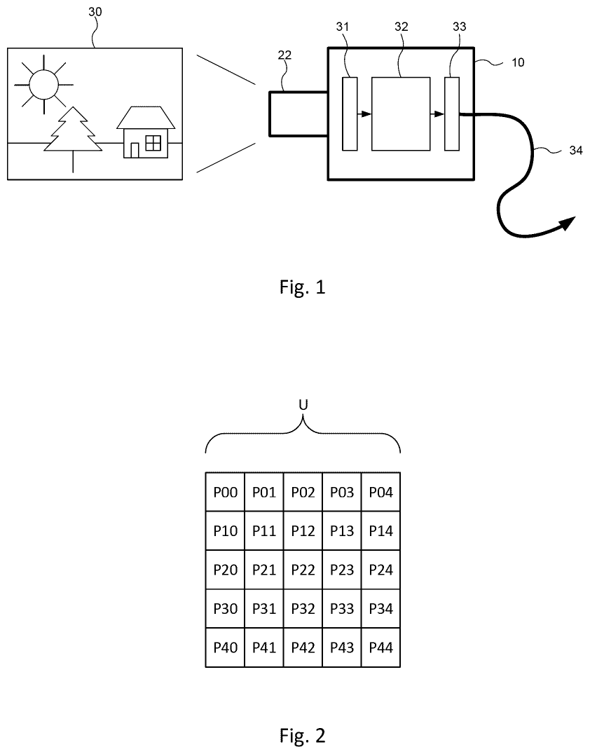

The structure and function of an electronic camera, e.g., a digital industrial camera, are schematically and exemplarily shown in FIG. 1 and are described in more detail in DE 10 2013 000301 A1, for example. The camera 10 usually comprises imaging optics 22, e.g., a lens. The imaging optics are used to image a scene as an image 30 onto an image sensor 31. The image sensor 31 has a regular arrangement of pixels, which is referred to as a pixel array. This is usually in the form of a two-dimensional square grid. The image sensor 31 uses the pixels to generate pixel values, which together describe the image 30 as an image signal. Furthermore, the camera 10 usually comprises an image processing unit 32, which can, for example, comprise an FPGA, a processor (CPU), a microcontroller (MCU), an embedded processor, a graphics processor (GPU) and optionally also so-called accelerators. The image sensor 31 transmits the image signal in electrical form, e.g., analog or digital, to the image processing unit 32, which creates an image 33, usually corrected in many respects, and makes it available in electrical form for further processing via an interface 34.

Such cameras are often used to capture still images of objects, for example when materials or products are optically inspected for compliance with quality criteria in automated series production. In addition, such cameras are also used to record image sequences that show for example moving objects.

It is known for example from the EMVA standard 1288 that image sensors often exhibit inhomogeneities. For example, the electrical properties of a pixel P22 deviate significantly from the electrical properties of the pixels in a pixel neighborhood, e.g., the 5×5 neighborhood P00, P01, P02, P03, P04, P10, P11, P12, P13, P14, P20, P21, P23, P24, P30, P31, P32, P33, P34, P40, P41, P42, P43 and P44, which are schematically and exemplarily shown in FIG. 2.

Numerous non-uniformities are possible causes. Common causes include dark signal non-uniformity (DSNU), photoresponse non-uniformity (PRNU), and dark current non-uniformity (DCNU). The latter effect is particularly important in practice with the image sensors frequently used today, especially for images that are taken at low scene brightness with a long exposure time and/or high camera temperature, e.g., in microscopy. Another important cause of inhomogeneities is the so-called radio telegraph signal noise (RTS noise). This is pixel-by-pixel noise caused by random jumps in the offset value of a pixel.

There are effects that affect the majority of the pixels of an image sensor, for example, DSNU and PRNU. Such effects produce a mostly homogeneous spatial noise, which is referred to here as normal image noise. It reduces the perceived image quality, but usually does not cause individual pixels that contribute to these effects to be perceived as individually disturbing.

In contrast, deviations due to DCNU or RTS noise occur less frequently and then mostly affect individual pixels. Nobukazu Teranishi (“Dark Current and White Blemish,” Image Sensors, London, 2012) and Wang et al. (“Random Telegraph Signal in CMOS Image Sensor Pixels,” 2006) identified defects in the semiconductor crystal structure of the image sensor as the most likely causes.

DCNU-related deviations usually lead to pixel values that appear slightly brighter compared to the pixel values of the local neighborhood. It is technically possible for the pixels to assume a maximum possible value, but slight increases in brightness are much more common. Furthermore, the deviation is subject to a temporal fluctuation due to the stochastic nature of the dark current, which makes a so-called static correction with a pre-calculated correction value more difficult. Image sensors are exposed to high-energy cosmic radiation, particularly during transportation in an aircraft, but also during normal storage and operation. This radiation can lead to further defects in the semiconductor structure and thus to a change in the dark current distribution. The number of pixels affected by a high dark current then increases. Therefore, a correction based on a determination of affected pixels at a certain point in time, for example during production, can often only partially correct DCNU-related errors. It is, so to speak, blind to deviations that occur later.

Furthermore, the strength of a DCNU-induced deviation usually depends linearly on the exposure time and exponentially on the temperature. This makes a static determination of the strength of a deviation even more difficult.

For its part, RTS noise is also mostly due to errors in the crystal lattice of the image sensor's semiconductor crystal, which occur below the gate electrode of an amplifier transistor in the pixel. In the case of image sensors that work with correlated double sampling (CDS), as is often the case nowadays, this leads to a certain probability that the brightness of affected pixels will deviate upwards or downwards by a certain amount, which is superimposed with a temporal noise. Here too, it is virtually impossible to determine affected pixels at a specific point in time, for example, during production, as the finite probability of occurrence means that it cannot be guaranteed that the error will actually occur at the time of determination.

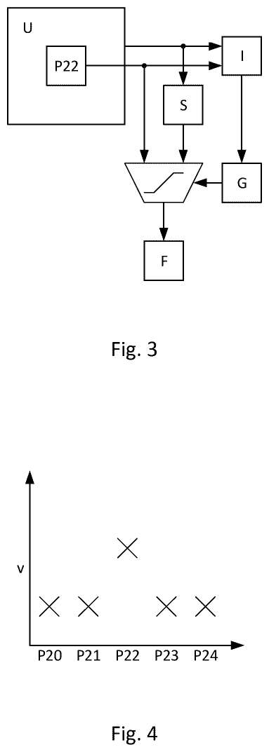

FIG. 3 schematically and exemplarily shows a correction method for correcting a value of a correction target pixel P22 of an image 30 of an electronic camera 10 according to an embodiment of the disclosure, wherein the correction method comprises:
determining a corrected value F of the correction target pixel P22 by means of a filtering, which is based on a weighted averaging of the value of the correction target pixel P22 and an estimation value S, wherein the weighted averaging is based on weight values G for the correction target pixel P22 and for the estimation value S,
wherein the weight values G are based on an inhomogeneity value I, which is determined based on a deviation of the value of the correction target pixel P22 from at least one neighborhood value, which is based on values of a plurality of pixels of a neighborhood U of the correction target pixel P22.

The correction process can, for example, be carried out by the image processing unit 32 of the camera 10 described above. Alternatively, however, the correction method can also be carried out outside the camera 10, for example, on an external computer, a mobile telephone or a hardware specially provided for this purpose.

If the inhomogeneity value I indicates a smaller inhomogeneity, the weight values G are selected so that the value of the correction target pixel P22 is weighted more heavily than if the inhomogeneity value I indicates a greater inhomogeneity, and the estimation value S is weighted less heavily than if the inhomogeneity value I indicates a greater inhomogeneity.

In this embodiment, the weighted averaging is performed continuously in dependence of the inhomogeneity value I. In particular, the inhomogeneity value I has a value range from a minimum value, which indicates a minimum inhomogeneity, to a maximum value, which indicates a maximum inhomogeneity, wherein, if the inhomogeneity value I is equal to the minimum value, the value of the correction target pixel P22 is weighted maximally, here with a weight value G equal to 1, and the value of the estimation value S is weighted minimally, here with a weight value G equal to 0, and, if the inhomogeneity value I is equal to the maximum value, the value of the correction target pixel P22 is weighted minimally, here with a weight value G equal to 0, and the value of the estimation value S is weighted maximally, here with a weight value G equal to 1. In this embodiment, the minimum value is equal to 0 and the maximum value is equal to 1, wherein the weight value G for the correction target pixel P22 is equal to 1 minus the inhomogeneity value I and the weight value G for the estimation value S is equal to the inhomogeneity value I. In other embodiments, however, the minimum value and the maximum value may also have other values.

In this embodiment, the at least one neighborhood value comprises a first value and a second value, wherein the inhomogeneity value I is determined based on a comparison of the value of the correction target pixel P22 with the first value and a comparison of the value of the correction target pixel P22 with the second value. In particular, if the value of the correction target pixel P22 is less than or equal to the first value, and if the value of the correction target pixel P22 is greater than or equal to the second value, the inhomogeneity value I indicates that the correction target pixel P22 has no inhomogeneity.

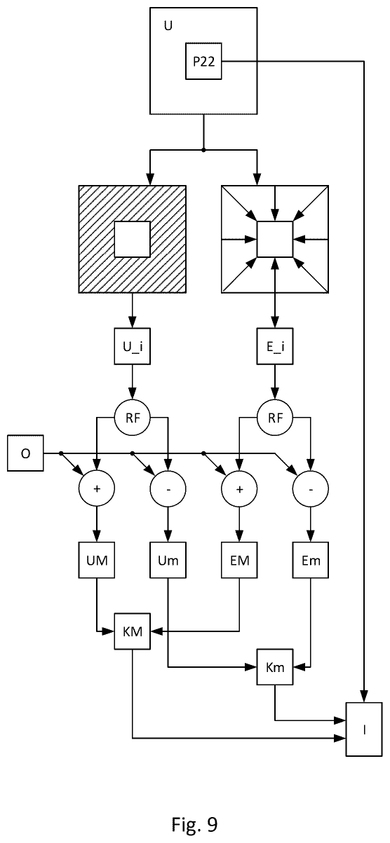

FIG. 9 shows schematic and exemplary details of the determination of the inhomogeneity value I according to an embodiment of the disclosure.

In this embodiment, the first value KM is determined based on two values, namely the m1-t largest value UM of the pixels of the plurality of pixels U_i of the neighborhood U of the correction target pixel P22 and the n1-t largest extrapolation value EM of at least two extrapolation values E_i, which are determined based on the plurality of pixels U_i of the neighborhood U of the correction target pixel P22 (see also FIG. 6). In the same way, the second value Km is also determined based on two values, namely the m2-t smallest value Um of the pixels of the plurality of pixels U_i of the neighborhood U of the correction target pixel P22 and the n2-t smallest extrapolation value Em of the at least two extrapolation values E_i. Here, m1, m2, n1 and n2 are natural numbers and are preferably equal to 1 or 2.

In other embodiments, the first value may also be based only on the m1-t largest value UM of the pixels of the plurality of pixels U_i of the neighborhood U of the correction target pixel P22 or only on the n1-t largest extrapolation value EM of the at least two extrapolation values E_i. In a corresponding manner, the second value can also be based only on the m2-t smallest value Um of the pixels of the plurality of pixels U_i of the neighborhood U of the correction target pixel P22 or only on the n2-t smallest extrapolation value Em of the at least two extrapolation values E_i.

As described, the values of pixels with highly inhomogeneous properties often deviate solitary from the values of the neighborhood pixels. FIG. 4 schematically and exemplarily shows values for an otherwise homogeneous image area in which a pixel P22 assumes an increased value due to inhomogeneity. The inhomogeneity-based increase in the value of pixel P22 has no effect on neighboring pixels P20, P21, P23 and P24.

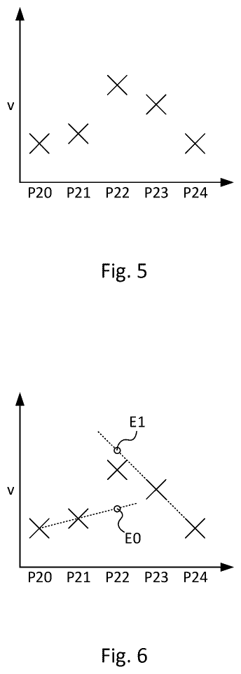

In contrast to FIG. 4, FIG. 5 schematically and exemplarily shows values for an image area that depicts a point-shaped bright spot, a so-called highlight, without inhomogeneity. With current digital cameras, the geometric extent of the pixels is usually in the order of magnitude of the resolution of the imaging optics or falls below it. As a result, light from a bright area of the scene is not only isolated on a single pixel, but also affects one or more neighboring pixels.

If the first value is based only or also on the m1-t largest value UM of the pixels of the plurality of pixels U_i of the neighborhood U of the correction target pixel P22 and the second value is based only or also on the m2-t smallest value Um of the pixels of the plurality of pixels U_i of the neighborhood U of the correction target pixel P22, a high-quality correction can be made in both cases. While in the first case, the filtering leads to a substantial change in the value of the correction target pixel P22 compared to the original value, in the second case, the filtering leads to no or only a slight change in the filtered value.

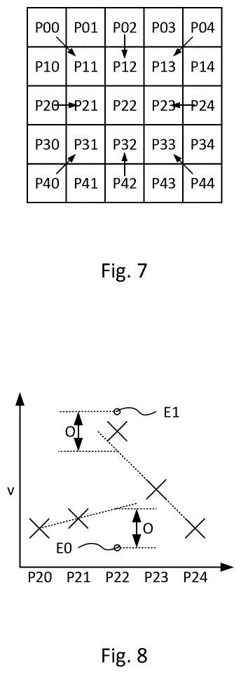

In this embodiment, the at least two extrapolation values E_i comprise eight extrapolation values, each of which is determined based on values of pixels of the plurality of pixels of the neighborhood U of the correction target pixel P22, which run directly towards the correction target pixel P22 in different directions. This is schematically and exemplarily shown in FIG. 7. The different directions include the directions horizontal from the left, horizontal from the right, vertical from the top, vertical from the bottom, diagonal from the top left, diagonal from the bottom right, diagonal from the top right and diagonal from the bottom left.

In this embodiment, the eight extrapolation values E_i are determined based on a linear interpolation. A first extrapolation value E_1 in the direction horizontally from the left can then be determined as E_1=2·P21-P20, a second extrapolation value E_2 in the direction horizontally from the right can be determined as E_2=2·P23-P24, a third extrapolation value E_3 in the direction vertically from above can be determined as E_3=2·P12−P02, a fourth extrapolation value E_4 in the direction vertically from below can be determined as E_4=2·P32−P42, a fifth extrapolation value E_5 in the direction diagonally from the top left can then be determined as E_5=2·P11−P00, a sixth extrapolation value E_6 in the direction diagonally from the bottom right can be determined as E_6=2·P33-P44, a seventh extrapolation value E_7 in the direction diagonally from the top right can be determined as E_7=2·P13-P04 and an eighth extrapolation value E_8 in the direction diagonally from the bottom left can be determined as E_8=2·P31-P40.

In other embodiments, the at least two extrapolation values may also be determined based on another extrapolation, such as a quadratic extrapolation, a cubic extrapolation, a higher degree polynomial extrapolation, a trigonometric extrapolation, or a logarithmic extrapolation.

In this embodiment, the m1−t largest value UM of the pixels of the plurality of pixels U_i of the neighborhood U of the correction target pixel P22 and the n1-t largest extrapolation value EM of the at least two extrapolation values E_i are additionally increased by a first offset value O. In a corresponding manner, the m2-t smallest value Um of the pixels of the plurality of pixels U_i of the neighborhood U of the correction target pixel P22 and the n2-t smallest extrapolation value EM of the at least two extrapolation values E_i are additionally reduced by a second offset value O, wherein the first offset value O is equal to the second offset value O (see FIG. 9).

Alternatively, in this embodiment, it is also possible to first increase the values KM or Km by the first offset value O or reduce them by the second offset value O.

It is preferred that the first offset value O and the second offset value O are selected such that they are in the order of magnitude of the spatial noise naturally occurring when images are captured by the electronic camera, e.g., due to DSNU and PRNU, and/or temporal noise, e.g., due to photon and/or readout noise. This is shown schematically and as an example in FIG. 8, wherein the first offset value O and the second offset value O are the same in the figure.

FIG. 11 schematically and exemplarily shows details of the determination of the estimation value S according to an embodiment of the disclosure.

In this embodiment, the estimation value S is determined based on an interpolation of the values of pixels of the neighborhood U of the correction target pixel P22, wherein the interpolation is based on a one-dimensional interpolation.

A direction estimation value R, which indicates an estimation value of the direction of an image structure within the neighborhood U of the correction target pixel P22, is determined, and the interpolation is based on a one-dimensional interpolation in the direction of the image structure, which is indicated by the direction estimation value R.

In this embodiment, the direction estimation value R is determined based on a comparison of a weighted sum of the magnitudes of pairwise differences of the values of pixels of the neighborhood U of the correction target pixel P22, which are arranged in a first direction with respect to each other, with a weighted sum of the magnitudes of pairwise differences of the values of pixels of the neighborhood U of the correction target pixel P22, which are arranged in a second direction with respect to each other.

In this embodiment, the estimated direction value R for the one-dimensional interpolation is determined in such a way that the sum of the magnitudes of the differences of the values of the pixels is lower in the direction of the interpolation than in other directions. Alternatively, it is also possible to determine the direction value R for the interpolation orthogonally to the direction in which the sum of the magnitudes of the differences in the values of the pixels is particularly high.

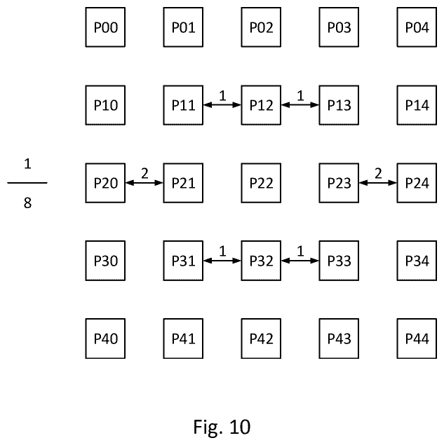

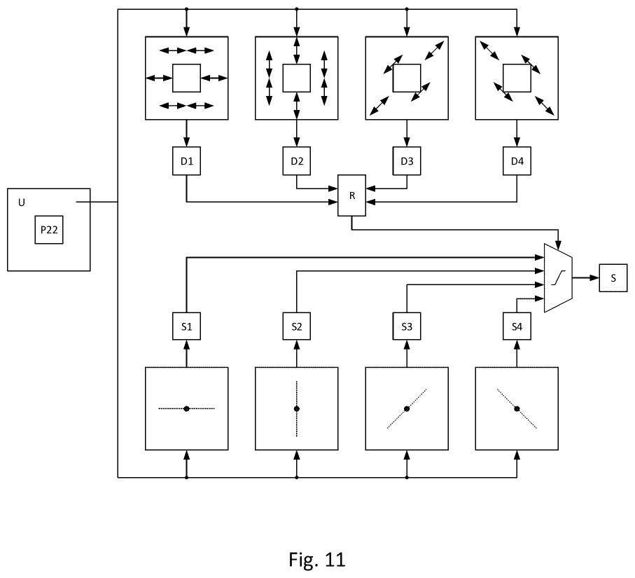

For example, as schematically and exemplarily shown in FIG. 10, the weighted sum of the magnitudes of pairwise differences of the values of horizontally arranged pixels can be determined as:

$$D 1 = 1 / 8 \cdot ( 1 \cdot \vert P 11 − P 12 \vert + 1 \cdot \vert P 12 − P 13 \vert + 2 \cdot \vert P 20 − P 21 \vert + 2 \cdot \vert P 23 − P 24 \vert + 1 \cdot \vert P 31 − P 32 \vert + 1 \cdot \vert P 32 − P 33 \vert )$$

In a corresponding manner, the weighted sum of the magnitudes of pairwise differences of the values of pixels arranged vertically to each other can be determined in an exemplary manner rotated by 90° as:

$$D 2 = 1 / 8 \cdot ( 1 \cdot \vert P 11 − P 21 \vert + 1 \cdot \vert P 21 − P 31 \vert + 2 \cdot \vert P 02 − P 12 \vert + 2 \cdot \vert P 32 − P 42 \vert + 1 \cdot \vert P 13 − P 23 \vert + 1 \cdot \vert P 23 − P 33 \vert )$$

In a similar way, weighted sums of the magnitudes of the difference between the values of pixels arranged diagonally to each other in ascending or descending order can also be determined. The weighted sum of the magnitudes of pairwise differences of the values of pixels arranged diagonally in ascending order can be determined, for example, as:

$$D 3 = 1 / 4 \cdot ( 1 \cdot \vert P 40 − P 31 \vert + 1 \cdot \vert P 21 − P 12 \vert + 1 \cdot \vert P 32 − P 23 \vert + 1 \cdot \vert P 13 − P 04 \vert )$$

and the weighted sum of the magnitudes of pairwise differences of the values of pixels arranged in descending diagonal order can be determined as:

$$D 4 = 1 / 4 \cdot ( 1 \cdot \vert P 00 − P 11 \vert + 1 \cdot \vert P 12 − P 23 \vert + 1 \cdot \vert P 21 − P 32 \vert + 1 \cdot \vert P 33 − P 44 \vert )$$

The determination of the estimated direction value R can then be based, for example, on the comparison of two or more of D1, D2, D3 and D4.

In this embodiment, the direction estimation value R is determined based on a comparison of weighted sums D1, D2, D3, D4 of the magnitudes of pairwise differences of the values of pixels of the neighborhood U of the correction target pixel P22, which are arranged in a plurality of directions with respect to each other, wherein a plurality of estimates S1, S2, S3, S4 are determined based on one-dimensional interpolations in the plurality of directions, wherein the estimation value S is based on a weighted averaging of the plurality of estimation values S1, S2, S3, S4, wherein the weighted averaging is based on weight values for the plurality of estimation values S1, S2, S3, S4, wherein the weight values are based on the direction estimation value R. For example, the plurality of weighted sums D1, D2, D3, D4 may be D1, D2, D3 and D4 as described above.

In the embodiments described above, the inhomogeneity value I, which is based on the deviation of the value of the correction target pixel P22 from the at least one neighborhood value, can additionally be scaled by a scaling factor, for example by multiplying its value by a factor or dividing it by a reciprocal factor during the determination. By scaling, the behavior of the filter can be adapted in such a way that, on the one hand, the pixels that stand out as inhomogeneous are sufficiently corrected and, on the other hand, the pixels that do not stand out as inhomogeneous experience no or only a slight change due to the filter.

While in the embodiments described above the interpolation is based on a one-dimensional interpolation, in other embodiments the interpolation can also be based on a two-dimensional interpolation. Alternatively, it is also possible that the estimation value S is determined based on a median formation or an averaging of the values of pixels of the neighborhood U of the correction target pixel P22.

The embodiments described above concern situations in which inhomogeneities can lead to both an increase and a decrease in a pixel value. In other embodiments, however, it is also possible that inhomogeneities only act in one direction, i.e., can only (or essentially only) lead to an increase or only (or essentially only) to a decrease in the pixel value. The comparison of the value of the correction target pixel (P22) can then be made, for example, only with the first value or only with the second value.

In practice, color image sensors are also frequently used that have a so-called mosaic filter, in which pixels are each provided with a color filter of one color from a plurality of colors. An example of such a mosaic filter is provided by U.S. Pat. No. 3,971,065 A, in which an arrangement of pixels is proposed, which is referred to as a “Bayer pattern” and is used very frequently. In such mosaic filters, the pixels with color filters of the same colors each form color planes, as shown, for example, in FIG. 1A of U.S. Pat. No. 3,971,065 A. With such filters, in an advantageous further development, the filtering can be carried out in such a way that it is based only on those pixels in the neighborhood that belong to the same color plane as the correction target pixel, i.e., whose color filter has the same color as the color filter of the correction target pixel. This avoids interfering influences of possible intensity differences of the different color planes caused by the colorfulness.

To ensure that a sufficiently large number of input pixels can be used, a 7×7 neighborhood can preferably be used.

Furthermore, the filtering can also be used for color images that contain a plurality of color planes (color channels) by applying the filtering separately to at least one color plane. Such images can, for example, be recorded with so-called three chip cameras, in which a set of prisms separates the images of the three different color channels from each other and images them on different image sensors, as shown, for example, in FR 2 386 220 A1. Images with a plurality of color planes can also be obtained, for example, by color interpolation or demosaicing. An example of this can be found in DE 10 2013 000301 A1.

Further variations of the disclosed embodiments can be understood and carried out by a person skilled in the art practicing the claimed disclosure from a consideration of the drawings, the description and the appended claims.

In the claims, the words “comprising” and “comprising” do not exclude other elements or steps and the indefinite article “a” does not exclude a plurality.

A single unit or apparatus may perform the functions of several elements listed in the claims. The fact that individual functions and/or elements are listed in different dependent claims does not mean that a combination of these functions and/or elements could not also be advantageously used.

The reference signs in the claims are not to be understood in such a way that the object and the scope of protection of the claims would be restricted by these reference signs.

In summary, there has been provided a correction method for correcting a value of a pixel of an image of an electronic camera, wherein the correction method comprises:
determining a corrected value of the correction target pixel by means of a filtering, which is based on a weighted averaging of the value of the correction target pixel and an estimation value, wherein the weighted averaging is based on weight values for the correction target pixel and for the estimation value,
wherein the weight values are based on an inhomogeneity value, which is determined based on a deviation of the value of the correction target pixel from at least one neighborhood value, which is based on values of a plurality of pixels of a neighborhood of the correction target pixel.

The various embodiments described above can be combined to provide further embodiments. All of the patents, patent applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A correction method for correcting a value of a correction target pixel of an image of an electronic camera, wherein the correction method comprises:
determining a corrected value of the correction target pixel by way of filtering, which is based on a weighted averaging of the value of the correction target pixel and an estimation value, wherein the weighted averaging is based on weight values for the correction target pixel and for the estimation value,
wherein the weight values are based on an inhomogeneity value, which is determined based on a deviation of the value of the correction target pixel from at least one neighborhood value, which is based on values of a plurality of pixels of a neighborhood of the correction target pixel.

2. The correction method according to claim 1, wherein, if the inhomogeneity value indicates a smaller inhomogeneity, the weight values are selected such that the value of the correction target pixel is weighted more heavily than if the inhomogeneity value indicates a greater inhomogeneity, and the estimation value is weighted less heavily than if the inhomogeneity value indicates a greater inhomogeneity.

3. The correction method according to claim 1, wherein the weighted averaging is performed continuously in dependence of the inhomogeneity value.

4. The correction method according to claim 1, wherein the at least one neighborhood value comprises a first value and/or a second value, wherein the inhomogeneity value is determined based on a comparison of the value of the correction target pixel with the first value and/or a comparison of the value of the correction target pixel with the second value.

5. The correction method according to claim 4, wherein, if the value of the correction target pixel is less than or equal to the first value, and/or, if the value of the correction target pixel is greater than or equal to the second value, the inhomogeneity value indicates that the correction target pixel has no inhomogeneity.

6. The correction method according to claim 4, wherein the first value is determined based on the m1-t largest value of the pixels of the plurality of pixels of the neighborhood of the correction target pixel and/or the second value is determined based on the m2-t smallest value of the pixels of the plurality of pixels of the neighborhood of the correction target pixel, wherein m1 and m2 are natural numbers and are preferably equal to 1 or 2.

7. The correction method according to claim 4, wherein the first value is determined based on the n1-t largest extrapolation value of at least two extrapolation values, which are determined based on the plurality of pixels of the neighborhood of the correction target pixel, and/or the second value is determined based on the n2-t smallest extrapolation value of the at least two extrapolation values, wherein n1 and n2 are natural numbers and are preferably equal to 1 or 2.

8. The correction method according to claim 7, wherein the at least two extrapolation values are each determined based on values of pixels of the plurality of pixels of the neighborhood of the correction target pixel, which run directly towards the correction target pixel in different directions.

9. The correction method according to claim 6, wherein the first value is determined based on the n1-t largest extrapolation value of at least two extrapolation values, which are determined based on the plurality of pixels of the neighborhood of the correction target pixel, and/or the second value is determined based on the n2-t smallest extrapolation value of the at least two extrapolation values, wherein n1 and n2 are natural numbers and are preferably equal to 1 or 2, and
wherein the first value is determined based on the m1-t largest value of the pixels of the plurality of pixels of the neighborhood of the correction target pixel and the n1-t largest extrapolation value of the at least two extrapolation values and/or the second value is determined based on the m2-t smallest value of the pixels of the plurality of pixels of the neighborhood of the correction target pixel and the n2-t smallest extrapolation value of the at least two extrapolation values.

10. The correction method according to claim 6, wherein the m1-t largest value of the pixels of the plurality of pixels of the neighborhood of the correction target pixel and/or the n1-t largest extrapolation value of the at least two extrapolation values is additionally increased by a first offset value and/or the m2-t smallest value of the pixels of the plurality of pixels of the neighborhood of the correction target pixel and/or the n2-t smallest extrapolation value of the at least two extrapolation values is additionally reduced by a second offset value, wherein the first offset value is equal to or different from the second offset value.

11. The correction method according to claim 1, wherein the inhomogeneity value that is based on the deviation of the value of the correction target pixel from the at least one neighborhood value is additionally scaled by a scaling factor.

12. The correction method according to claim 1, wherein the estimation value is determined based on an interpolation, a median formation, or an averaging of the values of pixels of the neighborhood of the correction target pixel.

13. The correction method according to claim 12, wherein the interpolation is based on a one-dimensional interpolation or a two-dimensional interpolation.

14. The correction method according to claim 13, wherein a direction estimation value, which indicates an estimation value of the direction of an image structure within the neighborhood of the correction target pixel, is determined, and the interpolation is based on a one-dimensional interpolation in the direction of the image structure indicated by the direction estimation value.

15. The correction method according to claim 14, wherein the direction estimation value is determined based on a comparison of a weighted sum of the magnitudes of pairwise differences of the values of pixels of the neighborhood of the correction target pixel arranged in a first direction with respect to each other with a weighted sum of the magnitudes of pairwise differences of the values of pixels of the neighborhood of the correction target pixel arranged in a second direction with respect to each other.

16. The correction method according to claim 14, wherein the direction estimation value is determined based on a comparison of weighted sums of the magnitudes of pairwise differences of the values of pixels of the neighborhood of the correction target pixel, which are arranged in a plurality of directions with respect to each other, wherein a plurality of estimates are determined based on one-dimensional interpolations in the plurality of directions, wherein the estimation value is based on a weighted averaging of the plurality of estimation values, wherein the weighted averaging is based on weight values for the plurality of estimation values, and wherein the weight values are based on the direction estimation value.

17. A correction apparatus for correcting a value of a correction target pixel of an image of an electronic camera, wherein the correction apparatus is configured to:
determine a corrected value of the correction target pixel by way of filtering, which is based on a weighted averaging of the value of the correction target pixel and an estimation value, wherein the weighted averaging is based on weight values for the correction target pixel and for the estimation value,
wherein the weight values are based on an inhomogeneity value, which is determined based on a deviation of the value of the correction target pixel from at least one neighborhood value, which is based on values of a plurality of pixels of a neighborhood of the correction target pixel.

18. An electronic camera, wherein the electronic camera comprises:
an image sensor having pixels for generating an image; and
the correction apparatus according to claim 17 for correcting a value of a correction target pixel of the image.

19. A computer apparatus, comprising a computing unit, which is configured to carry out the correction method according to claim 1.

20. A computer program product comprising a non-transitory computer-readable medium containing executable code for causing a computer apparatus to execute the correction method according to claim 1 when the code is executed on the computer apparatus.
